(19) United States
(12) Patent Application Publication
(10) Pub. No.: US 2015/0046092 A1
(43) Pub. Date: Feb. 12, 2015

(54) Global Calibration Based Reservoir Quality Prediction from Real-Time Geochemical Data Measurements

(71) Applicant: Weatherford/Lamb, Inc., Houston, TX (US)

(72) Inventors: Hamed Chok, Houston, TX (US); Simon N. Hughes, Houston, TX (US); Christopher N. Smith, Houston, TX (US); Michael C. Dix, Houston, TX (US)

(21) Appl. No.: 14/455,481

(22) Filed: Aug. 8, 2014

Related U.S. Application Data
(60) Provisional application No. 61/863,687, filed on Aug. 8, 2013.

(51) Int. Cl. G01V 5/04; G01V 5/10

(52) U.S. Cl. CPC G01V 5/045; G01V 5/101
USPC 702/11

(57) ABSTRACT

Real-time or near real-time estimates of reservoir quality properties, along with performance indicators for such estimates, can be provided through use of methods and systems for fully automating the estimation of reservoir quality properties based on geochemical data obtained at a well site.

### BACKGROUND

Hydrocarbon reservoir properties can ideally be determined by measurement and analysis of downhole data in real-time at the well site. Traditionally, these measurements are taken by logging-while-drilling or downhole wireline tools. Some of these measurements are obtained through induced neutron spectroscopy. With spectroscopy, the elemental composition of the formation can be determined. However, spectroscopic techniques are limited in that while they provide data about the geochemical elements of the formation, they do not necessarily help in interpreting the formation. For example, such techniques do not provide reservoir quality information such as porosity and permeability of the formation.

Reservoir quality can be assessed based on values such as porosity and permeability. These quality metrics for the rock properties are often determined by laboratory analysis, but this is not typically performed at the drill site. Instead, laboratory analysis of sample rock obtained from drill site is often used for planning future drilling.

It is expensive to case and prepare a well site for production of hydrocarbons. Accordingly, proper analysis and evaluation of rock formations can be critical in selecting locations and reservoirs to develop. Co-pending, commonly owned U.S. patent application Ser. No. 13/274,160, filed Oct. 14, 2011, entitled “Clustering Process for Analyzing Pressure Gradient Data,” which is incorporated by reference, describes various exploratory analysis techniques for interpreting various reservoir data to infer various formation properties. The subject matter of the present disclosure is directed to various enhancements to and framework extensions for the techniques described therein.

### SUMMARY

The subject matter of the present disclosure is directed to developing a system and method to provide real-time or near real-time estimates of reservoir quality properties along with performance indicators for such estimates. More specifically, a system and method for fully automating the estimation of reservoir quality properties based on geochemical data obtained at a well site are described.

### BRIEF DESCRIPTION OF THE DRAWINGS

FIG. 1 illustrates a method of determining reservoir quality predictions.

FIG. 2 illustrates an embodiment of a fully automated reservoir quality prediction method.

FIG. 3 illustrates a method to group a global data set with various data points into regression-regime clusters.

FIG. 4 illustrates the main computational steps of the offline learning framework.

FIG. 5 illustrates a real-time prediction algorithm implemented by the online ensemble predictor.

FIG. 6 illustrates a cluster pruning algorithm.

FIG. 7 illustrates a cluster merging algorithm.

FIG. 8 illustrates a hybrid strategy incremental clustering algorithm.

FIG. 9 is a block diagram illustrating network architecture 900 according to one or more disclosed embodiments.

FIG. 10 is a block diagram illustrating a computer which could be used to execute the clustering-based prediction algorithm according to one or more embodiments.

### DETAILED DESCRIPTION

Real-time data collection at a well site is often obtained through downhole wireline tools using spectroscopy. Data may be obtained through examining samples of rock retrieved from the borehole, although detailed measurements from samples are typically obtained in a laboratory setting. Laboratory results, especially for reservoir quality measurements, are not feasible in real-time. Accordingly, reservoir quality data measurements are not typically available to be able to make real-time decisions.

The benefits of having real-time interpretations of data collected at a well site include optimizing business and technical decisions. Interpretation of data during the drilling process could help in geo-steering drilling, determining where and when to take coring points, determining where to create perforations in the casing, looking for optimal spots in formations such as shale, determining where to launch horizontal drilling, and the like.

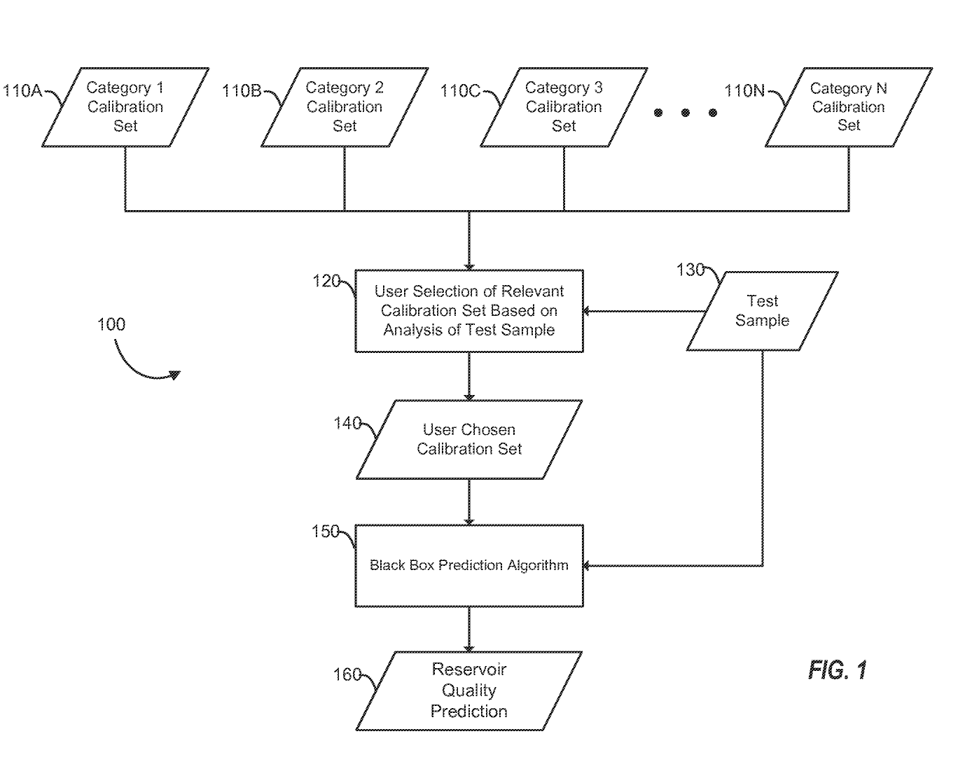

FIG. 1 illustrates a naïve category-specific calibration-based method 100 of determining a reservoir quality prediction. A user may have access to a large number of data sets 110A-110N obtained from prior drilling, analysis, and laboratory testing. These data sets are typically separated into categories 110A-110N based on a certain type of categorization, such as geographic locations, rock types, field or well similarities, or the like. A test (measured) sample 130 from a reservoir which is being drilled may be compared against one of the calibration sets to determine a prediction for the measured sample's unknown properties characterizing the reservoir quality. In 120, the user may examine the test sample 130 and select a relevant calibration set 140 to compare against the test sample 130. The selection of the relevant calibration set at 120 is typically not an automated process. This manual selection typically results in calibrating based on a characteristic of the calibration set that is related to the reservoir that is being explored. In this way, a sandstone test sample may be calibrated against a sandstone calibration set, a shale test sample to a shale calibration set, and so on. After the relevant calibration set is selected, measurements taken from the test sample are correlated against measurements stored in the calibration set, using some type of prediction algorithm (150), and a reservoir quality estimate may be determined, as shown at 160.

Because of the manual nature of selection, and because the selection may have to be determined from a laboratory analysis, the reservoir quality estimate may not be available in a timely manner to make an impactful real-time decision based on the data. Also, if the correct calibration set is not correctly chosen, then the derived reservoir quality estimate on the test sample may not be accurate. Furthermore, such process is subjective to the set of pre-chosen categories, which may not be totally effective in deriving accurate estimates or providing guarantees on the quality of the estimates.

As described above, the naïve methods of evaluating data from a test sample to comparable calibration sets typically involves a manual analysis, which may not be achievable in real-time and be subject to error. Further, combining all previously gathered data into one large calibration set has clear disadvantages as well. As to date, it does not appear that successful reservoir quality prediction estimates have been determined from a universal autonomous model using global geochemical data or even from site-specific models.

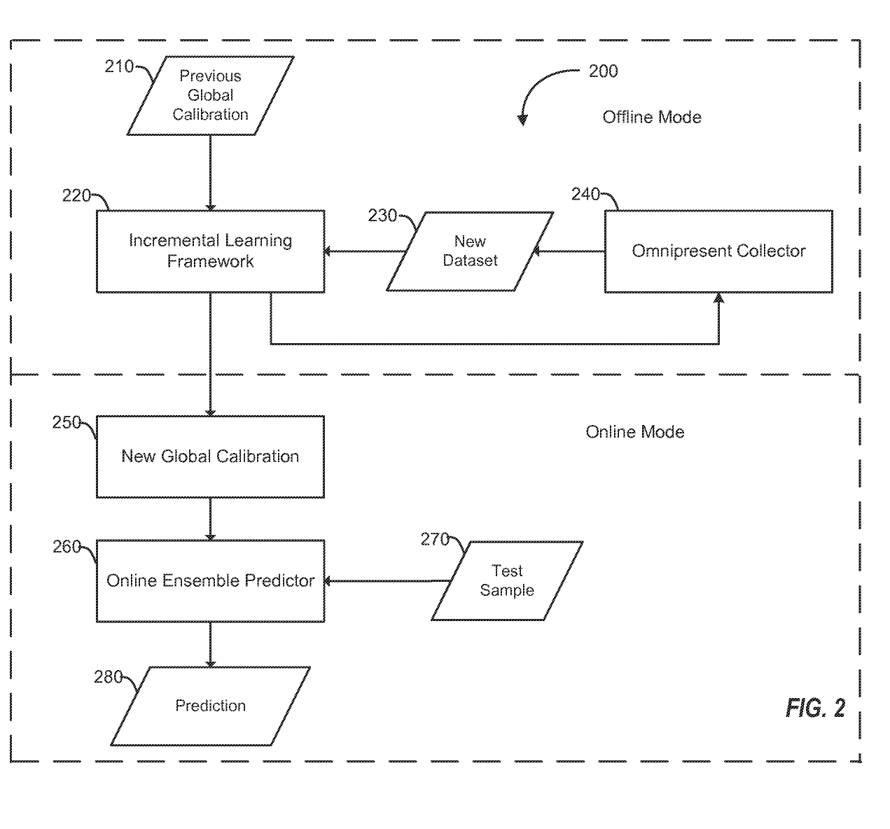

FIG. 2 illustrates a method 200 to determine a reservoir quality prediction from a global calibration incrementally updated by a learning framework. Given a readily existing global calibration (initially, when no prior data is available, such calibration may be null), the learning framework continuously receives a new batch of data points from an omnipresent data collector 240 and may process it incrementally either sample by sample and/or in batch mode to augment/update the existing global calibration. The new input data 230 may consist of geochemical data collected from drilling or testing operations being performed worldwide coupled with corresponding reservoir property.

The data may include (but is not limited to) geochemical element properties, grain and particle shape/size properties, and corresponding reservoir properties that have been identified for a given sample of rock or identified by a particular location. The data may have been gathered through techniques such as neutron logging tools, energy dispersive X-ray fluorescence (ED-XRF), wave-length dispersive X-ray fluorescence (WD-XRF), X-ray diffraction (XRD), Fourier transform infrared spectroscopy (FTIR), nuclear magnetic resonance (NMR), laser-induced spectroscopy (LIBS), laser-induced plasma spectroscopy (LIPS), plasma forming methods of spectroscopy, including others. Once new data is received, appropriate (data-dependent) mathematical pre-processing may be performed.

When a test sample 270 is obtained in real-time, the up-to-date global calibration 250 generated by the learning framework are fetched and fed to a prediction algorithm 260. The prediction algorithm, in turn, generates a reservoir quality prediction 280 for the given test sample 270.

Accordingly, the learning process of method 200 operates as an incremental learning algorithm, which continuously refines itself with the additional data sets. As the global calibration grows, the ability to predict as well as the quality of the predictions will likely improve, but even at earlier stages when less data is available, some predictions may be possible. One autonomous aspect about method 200 is its ability to continuously integrate new data into the global calibration model without any user intervention.

When a test sample 270 is obtained in real-time, the up-to-date global calibration 250 generated by the learning framework are fetched and input into the prediction algorithm 260. The prediction algorithm 260 would then generate a reservoir quality prediction 280 by identifying the relevant subset of the calibration from which a prediction for the given test sample 270 is constructed. Thus, an additional autonomy of method 200 stems from its selective nature allowing it to pick the subset of the global calibration most relevant to the current sample's prediction. Such inherent ability allows it, in particular, to detect unusual samples for which no accurate prediction may be possible. In more general terms, the identification of relevant calibration subset allows not only the computation of an estimate, but also the construction of a performance measure around such estimate.

The reservoir quality prediction may provide estimates on properties such as porosity or permeability. Additional properties that may be estimated could include total organic carbon (TOC), bulk density, Spectral Gamma Ray (SGR), mineralogy, brittleness, Young's Modulus, and the like. This prediction framework may be separate for each property such that a separate instance of the method framework could be utilized for each of the properties. In effect, a reservoir quality predictor for porosity could have a different calibration of geochemical data than a reservoir quality predictor for permeability. In this way, the calibration and predictions for one property could be performed independently of the calibration and predictions for other properties. In a computer system, these separate models could be executed in a parallel manner. Furthermore, because (as it shall be later described) the calibration is naturally partitioned into clusters, the complete cluster collection may be maintained over a parallel network of computer nodes.

The dotted boxes in FIG. 2 additionally show that the method may be separated into an offline mode (upper box) and an online mode (lower box). The offline mode may be performed at any time, without specific time constraints. The online mode may be performed on-site, for example, when new geochemical data is acquired from a test sample. The online mode allows for the input of test sample data 270 and the quality prediction output 280. The dotted boxes do not represent an absolute separation of tasks for the execution of the framework; in certain situations, it may be desirable to move some or all actions in or out of a particular box, allowing for a flexible architecture in implementing the prediction framework.

Offline Clustering Based Calibration and Real-Time Prediction

A clustering algorithm partitions the global data set into global cluster sets each composing of non-overlapping clusters such that the samples in each cluster admit an intrinsic relationship (e.g., linear or quadratic) that can be modeled by a regression regime. The clustering algorithm achieves the regime-based clustering via minimizing the sum of all intra-cluster squared errors wherein the intra-cluster errors are assessed in terms of the regime fit through the data points within the associated cluster. The clustering uses the geochemistry coupled with the corresponding reservoir quality property. This may include information gathered from laboratory testing, on-site testing, downhole testing, etc. The data obtained from a sample may then be preprocessed to account for differences in the statistical error rates for data obtained by different methods. This allows for variable data quality gathered from different locations by different instruments to be used. The data may be normalized through pre-processing and the algorithm allows for noise within the data.

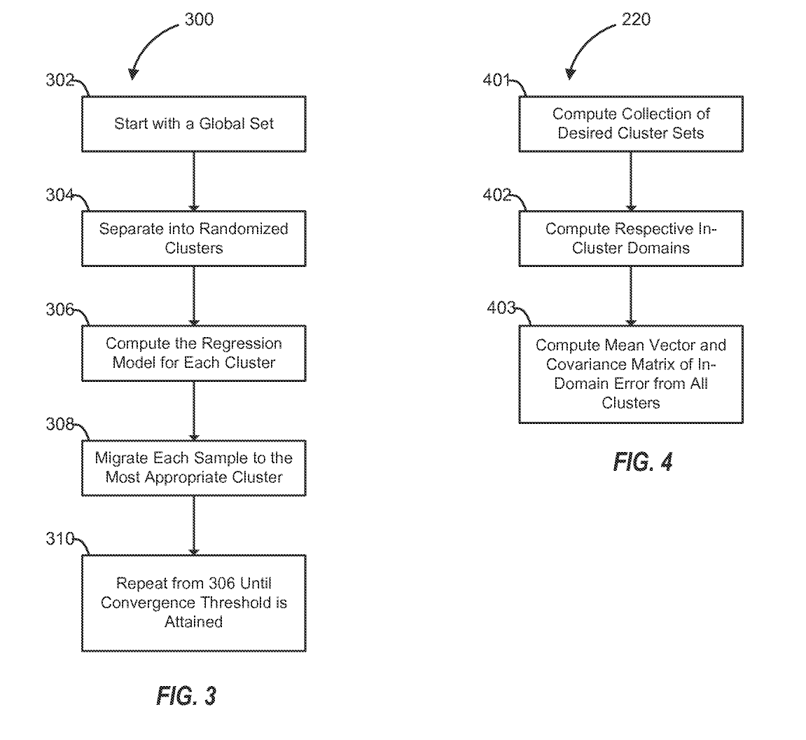

A method 300 for clustering is seen in FIG. 3. Initially, as shown at 302, the pre-collected data set is input into the clustering algorithm. Then, at 304, the data points are randomly grouped into a predetermined number of clusters, or partitions. In 306, the regression model for each of the clusters is computed. At 308, each data point from each cluster is compared against the set of regression models computed for each of the clusters. The data point is then migrated to the cluster whose regression model most closely fits through the data point. In doing this, a predetermined number of regression models have been created (i.e., one for each cluster), and the groupings of data points within clusters, which were initially completely random, are refined and become less random. As is shown in 310, the actions from 306 and 308 may be repeated iteratively to continue to refine the regression models and more optimally group the data points into clusters. After the clusters have converged up to a threshold, or after a point where the clusters (and/or regression models) are no longer changing or minimally changing, the method 300 is considered complete. This alternating optimization (AO) principle to cluster data based on regression regimes is exploited in the suite of clustering algorithms described in our co-pending, commonly owned U.S. patent application identified above and the prior art referenced therein. This principle will form the basis of the clustering algorithm herein used to aid in property prediction.

Randomized algorithm 300 may converge to only a locally optimal clustering depending on the initialization of the partitions in process step 304. Here, the term “local” refers to a local minimum of the optimization objective function (sum of squared errors mentioned above), not to be confused with geographic locality. A single cluster of data points may be a hybrid set of data from different geographic locations in the world and/or different chemical compositions, whatever makes sense from the perspective of the clustering optimality objective. Furthermore, because the process is based on a local optimization, it is beneficial if the algorithm is repeated with several initializations. Additionally, the number of clusters may also be varied such that multiple clustering solution configurations are considered. In this way, a collection of top-performing clustering solutions may be maintained. All maintained locally-optimal solutions will constitute a solution population (cluster regimes), which collectively paint a better picture of the relationships and patterns within the data. Note that whereas each clustering solution individually contains non-overlapping clusters, cross-solution clusters may well be overlapping.

The clustering algorithm 300 yields a cluster set wherein each cluster admits an intrinsic regime that “reasonably” fits the in-cluster samples, i.e., the intrinsic regime is able to map the input of any sample in the cluster to its property up to a certain error. Therefore, to predict a new input sample of an unknown property, it suffices to identify one or more sample clusters that can be qualified as “representative” of the given input sample (measured sample of unknown property). For any of the identified clusters, its underlying regime can be used to map the input of the given sample to an estimated property. Any particular sample cluster may be qualified as “representative” of a given input sample if the input domain that the cluster spans contains that of the given new measured sample. The input domain spanned by any particular cluster may be estimated from the distribution of the inputs of the samples that it contains.

Characterizing the input domain of any particular cluster may be reduced to a density estimation problem given the inputs of the in-cluster samples. Formally, any measurable input is qualified as part of an in-cluster domain if it can be sampled from the distribution of the inputs of the in-cluster samples. Density estimation is a well-studied problem, and there exists a wealth of methods in the literature that can be used to solve it. Additional approaches may include methods for data domain description capable of discerning inliers from outliers. Another class of approaches is to use a binary classification method. Instead of using the in-cluster samples to define the definition domain of a particular cluster regime, it is possible to use the data samples from all clusters and identify all sample inputs that are fitted by the particular cluster regime up to a maximum error threshold. The idea is to then build a classifier model from the available data to be able to classify the predictability of any measurable input by any particular cluster regime. Predictability over any particular measurable input sample may be classified as either positive or negative, wherein positive means that the input sample may be predicted using the underlying cluster regime within the maximum allowed error and negative otherwise.

Regardless of the in-cluster domain characterization method, we can infer the in-domain error distribution for any particular cluster regime using the available data. When a particular newly measured sample input is cast to the domain of a particular cluster regime, the in-domain regime error distribution may be used as an estimate for the distribution of the error in the prediction of the given measured input by the underlying cluster regime. With such estimated prediction error distribution, it is possible to define an estimate quality measure or error bounds around any predicted estimate. The following pseudo-code outlines the main computational steps of the offline learning framework (220, FIG. 2), which are also illustrated in FIG. 4.

Step 1: Compute a collection of desired cluster sets (401)
Step 2: Compute respective in-cluster domains (402)
Step 3: Compute the mean vector and covariance matrix
of the in-domain errors from all clusters (403)

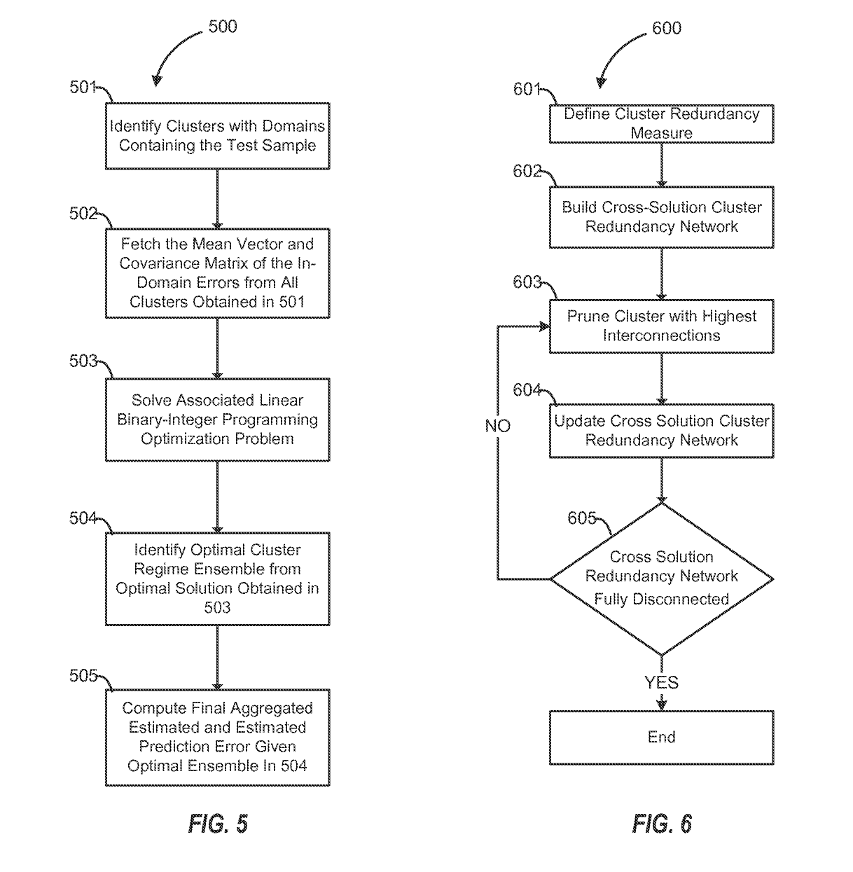

A measured input sample may belong to one or more in-cluster domains therefore meriting a prediction from each underlying cluster regime. An aggregate of the predictions from relevant cluster regimes may improve each individual prediction by virtue of minimizing the prediction error variance. Real-time sample prediction is performed based on one or more cluster regimes estimated to be most relevant to a given measured sample whose property is to be predicted, if such relevant clusters exist. Given an input sample and a global collection of clusters, clusters whose domains contain the input sample are identified; and a relevant subset of such clusters is selected, each with their own local regression model (regime). The predictions from all the relevant clusters are then aggregated by the algorithm. An aggregate prediction may be defined as the average prediction of all relevant cluster regimes corrected for their average prediction error offset. Such offset correction will ensure that the expected value of the aggregate prediction will tend to the true value. The set of clusters whose individual estimates (predictions), when aggregated, yield the most contained prediction error distribution are qualified as relevant and are elected as the predicting regime ensemble. In other words, a regime ensemble is sought that minimizes the estimated prediction error variance. The ensemble election for error variance minimization may be set up as an optimization problem. For instance, such optimization problem can be cast as a constrained binary integer programming problem with linear objective for which real-time aware solutions can be devised. Alternate schemes for electing the predicting regime ensemble other than via error variance minimization may be defined depending on the particular chosen in-cluster domain characterization. A pseudo-code outlining a real-time prediction algorithm 500 that may be implemented by online ensemble predictor 260 is shown below and is illustrated in FIG. 5.

Step 1: Identify clusters with domains containing the test
sample (501)
Step 2: Fetch the mean vector and covariance matrix of the
in-domain errors from all clusters obtained in step 1 (502)
Step 3: Solve the associated linear binary-integer programming
optimization problem (503)
Step 4: Identify the optimal cluster regime ensemble from the
optimal solution obtained in step 3 (504)
Step 5: Compute final aggregated estimate and its estimated
prediction error variance given the optimal ensemble in step 4 (505)

Incremental Clustering Updates and Global Calibration Scalability

As shown at 220, 230, and 240 of FIG. 2, the global calibration maintained as a collection of global cluster sets along with the respective domains and error distributions may be continuously and asynchronously updated as new data samples are acquired. This is beneficial in that the prediction algorithm will have both an increased ability and accuracy of predictions as the overall knowledge base is augmented. This is implicitly asserting that a previously calculated solution of clusters may not be adequate for prediction, as its underlying data may not yet span well enough the geochemical space over which prediction is to be performed. Accordingly, the clustering-based calibration needs to be incrementally updated as new data sets are acquired. This raises a question as to how an incremental clustering update could be performed efficiently, as well as how good scalability in terms of the size of global data set could be achieved. It also raises the question as to how new knowledge is to be discerned from old knowledge before being integrated.

As noted above, the method of clustering starts from a set of initial regression models and then iteratively updates the regression models until convergence to a locally optimal solution. When a new data set is received, it may be clustered separately as an individual batch. When the existing data set clusters are merged with the clusters of the new data batch, the iterative process of refining clusters may be continued until convergence.

It should be noted that the initial global regression models are subjective to the choice of the two solutions from each of the two constituent datasets in the merger. Therefore, the process can be repeated for all possible pairs of individual solutions to obtain all possible solutions to the global dataset issuable from the existing solutions of each of the two constituent datasets. Hence, if the existing global dataset has X clustering solutions (each solution may contain any number of clusters), and the new dataset has Y clustering solutions, then the updated global dataset will have XY clustering solutions.

As may be expected, this process of incrementally adding new data may prohibitively increase the number of clustering solutions. Not only is the total number of solutions compounded, but each updated global cluster solution (amongst the total number of XY solutions) will have as many clusters as there are in its two constituent cluster solutions combined (unless one or more clusters become empty during the optimization). To contain the complexity of the global calibration set and, in turn, that of the clustering-based prediction algorithm, similar clusters across global clustering solutions may be pruned (assure cluster diversity across solutions by pruning redundant clusters). Additionally or alternatively, the total number of underlying clusters in every global clustering solution may be limited.

To qualify clusters as similar or redundant for the purpose of pruning, a redundancy measure that is a function of the data points within a cluster and/or the cluster regime may be defined. A cluster redundancy network (graph) may be computed involving all global clusters, with the network connections (edges) representing cluster redundancy. The pruning algorithm may then employ a greedy strategy to fully disconnect the redundancy network while minimizing the number of pruned clusters. A pseudo-code for an example pruning algorithm, also illustrated in FIG. 6, is given below. It should be noted that the general outlined steps of the pruning algorithm can be efficiently implemented for the case of the batch incremental learning.

| | |
|---|---|
| Step 1: | Given a cluster redundancy measure (601) |
| Step 2: | Build the cross-solution cluster redundancy |
| | network (602) |
| Step 3: | Repeat |
| | Step 3.1: Prune the cluster with highest |
| | interconnections (603) |
| | Step 3.2: Update the cross-solution cluster |
| | redundancy network (604) |
| Step 4: | Until cross-solution cluster redundancy network |
| | is fully disconnected (605) |

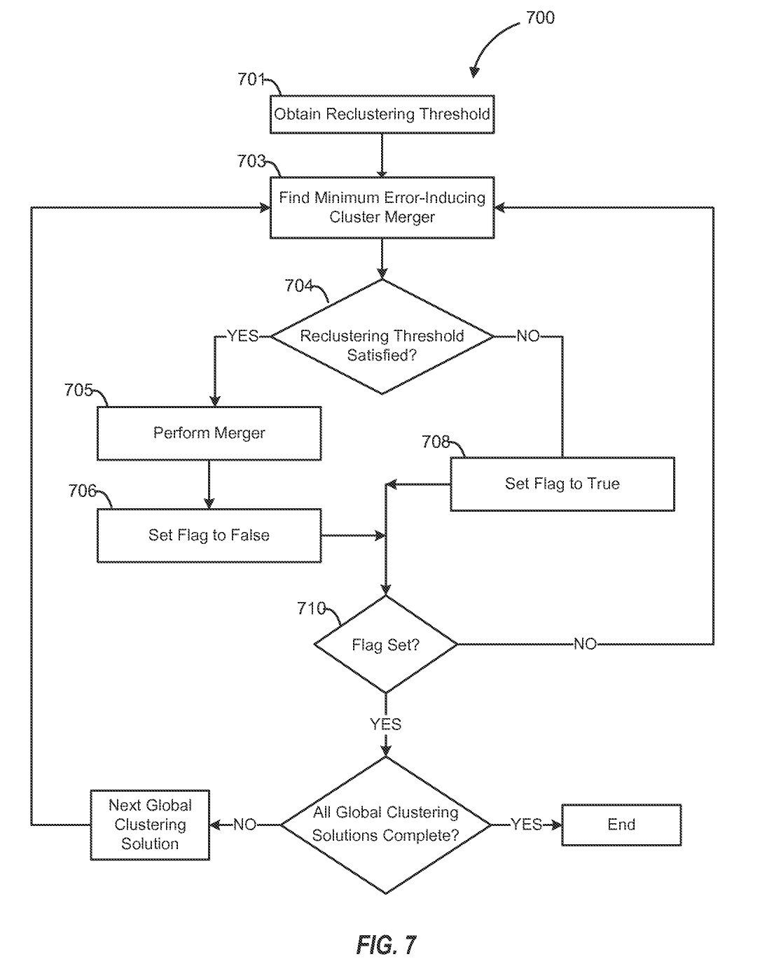

A second technique to reduce the total number of underlying clusters is to have a re-clustering algorithm as part of the calibration process to successively merge clusters into parent clusters up to when a convergence criterion is achieved. The convergence criterion may be defined in terms of the maximum allowed number of clusters per clustering solution, or alternatively the maximum intra-cluster error variance allowed. In each merging iteration, the cluster merger inducing the minimum increase the intra-cluster fitting error variance of the new parent regression model is selected. A merging algorithm pseudo-code is illustrated below and in FIG. 7. As with the pruning algorithm, the re-clustering algorithm can be efficiently implemented in conjunction with the incremental batch clustering updates.

| | |
|---|---|
| Step 1: | Given a re-clustering threshold (e.g., maximum |
| | relative error increase) (701) |
| Step 2: | For each global clustering solution |
| | Step 2.1: Repeat |
| | Step 2.1.1: find minimum error-inducing cluster merger (703) |
| | Step 2.1.2: if re-clustering threshold is satisfied (704) |
| | Step 2.1.2.1: perform merger (705) |
| | Step 2.1.2.2: set flag to false (706) |
| | Step 2.1.3: else |
| | Step 2.1.3.1: set flag to true (708) |
| | Step 2.1.4: end if |
| | Step 2.2: Until flag (710) |
| Step 3: | end for |

In addition to cluster reduction schemes, a new batch of data points may be used to incrementally update the global clustering without increasing the complexity (size) of the global cluster sets. Under such scenario, new data points may be inserted one point at a time into each current cluster set. For every new point, the most fitting cluster within each cluster set is identified, the new data point is inserted into it, and the clustering optimization is carried on until convergence. While such an approach does not increase the complexity of the clustering solutions, it may induce an increase in the total intra-cluster error of one or more clusters.

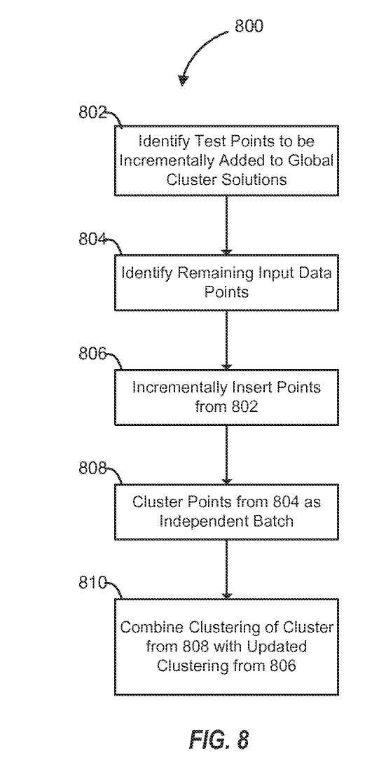

To achieve a compromise between the complexity of the cluster calibration sets and the accuracy of the cluster regimes, a hybrid approach involving the sample-wise increment and the full batch increment may be utilized. Under such scheme, data samples that can be predicted with the current clustering without increasing the spread of the fitting error distribution may be used to update the clustering using the sample-wise incremental update. A sufficient (but not necessary) condition for the existence of such sample points is that if for a given clustering solution, the most fitting cluster regime to the sample point can predict such point with accuracy within its intra-cluster error distribution variance then such sample may be inserted and further cluster optimization may be carried on. For all the samples that do not satisfy the sufficient condition, they may be used to update the clustering according to the batch-based incremental update (i.e., the batch is clustered separately and then combined with the current clustering as mentioned previously). Additional adaptively incremental clustering schemes may be utilized. A pseudo-code for the hybrid-strategy incremental clustering algorithm is given below and is illustrated in FIG. 8.

Step 1: Identify test points that can be incrementally added
into the global cluster solutions (802)
Step 2: Identify remaining set of input data points (804)
Step 3: Incrementally insert the points identified in step 1 into
the current global cluster sets (806)
Step 4: Cluster the points identified in step 2 as independent
batch of points (808)
Step 5: Combine the clustering of the point batch with the
updated global clustering obtained in step 3 (810)

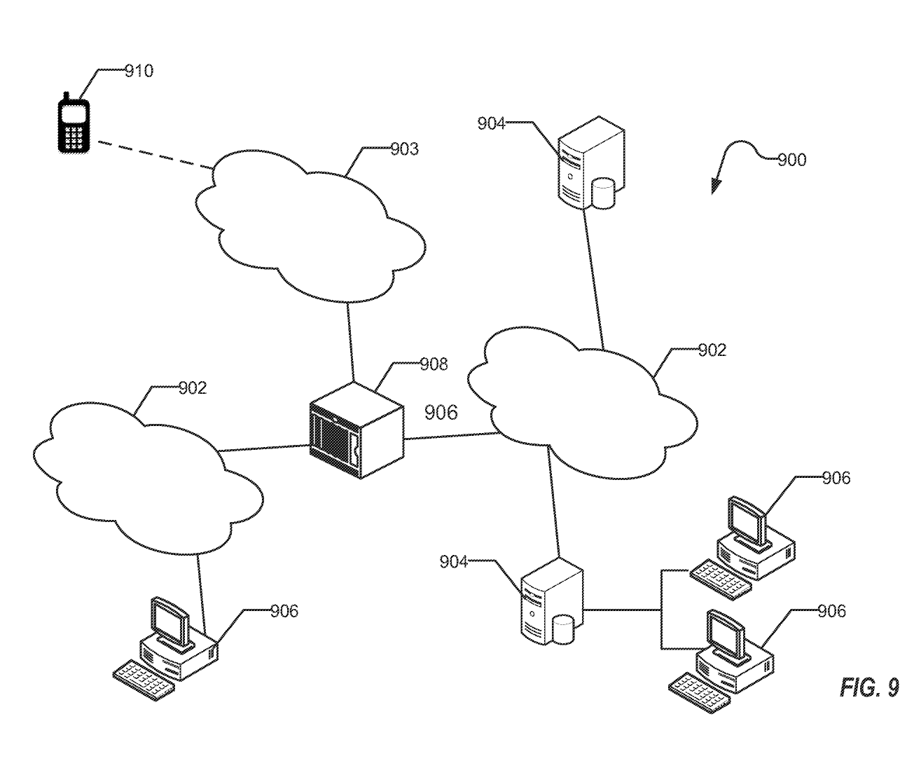

Referring now to FIG. 9, an infrastructure 900, which may be used to execute embodiments of the algorithm described above, is shown schematically. Infrastructure 900 contains computer networks 902. Computer networks 902 include many different types of computer networks available today, such as the Internet, a corporate network or a Local Area Network (LAN). Each of these networks can contain wired or wireless devices and operate using any number of network protocols (e.g., TCP/IP). Networks 902 are connected to gateways and routers (represented by 908), end user computers 906, and computer servers 904. Also shown in infrastructure 900 is cellular network 903 for use with mobile communication. As is known in the art, mobile cellular networks support mobile devices 910, which may include devices such as mobile phones or tablet computers (not separately shown). Mobile devices may be used to input newly acquired data into the global calibration set or to review reservoir quality prediction metrics on site to allow for real-time decision making.

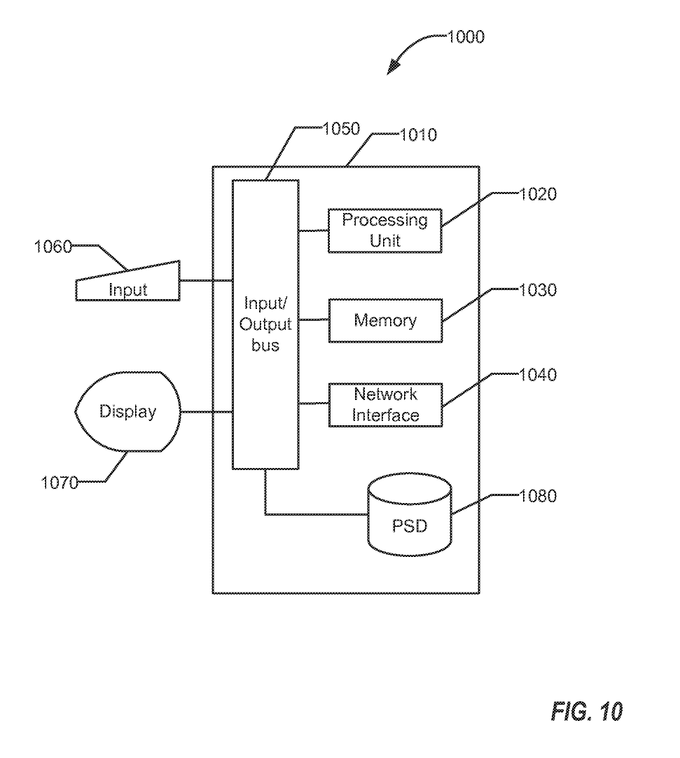

Referring now to FIG. 10, an example processing device 1000 for use in executing the clustering algorithm according to one embodiment is illustrated in block diagram form. Processing device 1000 may serve as processor in a mobile device 910, gateway or router 908, client computer 906, or a server computer 904. Example processing device 1000 comprises a system unit 1010 which may be optionally connected to an input device for system 1060 (e.g., keyboard, mouse, touch screen, etc.) and display 1070. A program storage device (PSD) 1080 (sometimes referred to as a hard disk, flash memory, or computer readable medium) is included with the system unit 1010. Also included with system unit 1010 is a network interface 1040 for communication via a network (for example, cellular or computer) with other computing and corporate infrastructure devices (not shown) or other mobile communication devices. Network interface 1040 may be included within system unit 1010 or be external to system unit 1010. In either case, system unit 1010 will be communicatively coupled to network interface 540. Program storage device 1080 represents any form of non-volatile storage including, but not limited to, all forms of optical and magnetic memory, including solid-state, storage elements, including removable media, and may be included within system unit 1010 or be external to system unit 1010. Program storage device 1080 may be used for storage of software to control system unit 1010, data for use by the processing device 1000, or both.

System unit 1010 may be programmed to perform methods in accordance with this disclosure. System unit 1010 comprises one or more processing units, input-output (I/O) bus 1050 and memory 1030. Memory access to memory 1030 can be accomplished using the communication bus 1050. Processing unit 1020 may include any programmable controller device including, for example, a mainframe processor, a mobile phone processor, a general purpose processor, or the like. Memory 1030 may include one or more memory modules and comprise random access memory (RAM), read only memory (ROM), programmable read only memory (PROM), programmable read-write memory, and solid-state memory.

Processing device 1000 may have resident thereon any desired operating system. Embodiments of disclosed prediction algorithm may be implemented using any desired programming language, and may be implemented as one or more executable programs, which may link to external libraries of executable routines that may be supplied by the provider of the detection software/firmware, the provider of the operating system, or any other desired provider of suitable library routines. As used herein, the term “a computer system” can refer to a single computer or a plurality of computers working together to perform the function described as being performed on or by a computer system.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment. It will be apparent to one skilled in the art that a method need not be practiced in the exact sequence listed in a figure or in a claim, and rather that certain actions may be performed concurrently or in a different sequence.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A method of estimating one or more reservoir quality parameters of a hydrocarbon reservoir from a global calibration data set, the method comprising:
obtaining one or more measured parameters from a test sample of a reservoir being drilled; and
using a programmable processing device to perform an evaluation of the one or more measured parameters of the test sample with respect to the global calibration data set, wherein the evaluation includes
identifying the clusters whose domains include the one or more measured parameters of the test sample;
selecting at least a subset of the identified clusters; and
evaluating the regression regimes of the at least subset of the identified clusters based on the measured parameters to determine an estimate of the one or more reservoir quality parameters;
wherein the at least a subset of the identified clusters is selected from the global calibration data set by an online ensemble estimator algorithm executed by the programmable processing device.

2. The method of claim 1 wherein the programmable processing device comprises a plurality of networked computing devices.

3. The method of claim 1 wherein the evaluation includes construction of a performance measure around the estimate of the one or more reservoir quality parameters.

4. The method of claim 1 wherein the online ensemble estimator is implemented using a binary integer-programming method to minimize the estimate variance.

5. The method of claim 1 wherein the learning algorithm executed by the programmable processing device comprises:
using the programmable processing device to randomly group the data points into a predetermined number of clusters;
using the programmable processing device to perform a regression analysis on each of the clusters;
using the programmable processing device to move one or more data points from a previously assigned cluster to another cluster whose regression model more closely fits the data point; and
using the programmable processing device to repeat the regression analysis and moving of one or more data points until a convergence threshold is reached;
using the programmable processing device to repeat the random grouping with different random initializations;
using the programmable processing device to vary the predetermined number of clusters;
using the programmable processing device to compute one or more in-cluster domains of the one or more clusters;
using the programmable processing device to compute one or more in-cluster error distributions of the one or more clusters
wherein the global calibration data set consists of the one or more clusters, the one or more in-cluster domains, and the one or more in-cluster error distributions.

6. The method of claim 5 wherein determining the one or more in-cluster domains comprises:
using a density estimation method; or
using a domain description method; or
using a binary classification method.

7. The method of claim 1 further comprising:
using the programmable processing device to update the global calibration data set by adding new data derived from one or more measured parameters of a reservoir.

8. The method of claim 7 wherein the new data comprises one or more items selected from the group consisting of: geochemical element properties, grain and particle shape/size properties, and corresponding reservoir properties identified for a given sample of rock or identified by a particular location.

9. The method of claim 7 wherein the new data is gathered by one or more techniques selected from the group consisting of: neutron logging, energy dispersive X-ray fluorescence, wave-length dispersive X-ray fluorescence, X-ray diffraction, Fourier transform infrared spectroscopy, nuclear magnetic resonance, laser-induced spectroscopy, laser-induced plasma spectroscopy, and plasma forming methods of spectroscopy.

10. The method of claim 7 wherein the update occurs without manual user intervention.

11. The method of claim 7 wherein using the programmable processing device to update the global calibration data set is performed in an offline mode.

12. The method of claim 1 wherein using the programmable device to perform an evaluation of the one or more measured parameters of the test sample is performed in an online mode when new geochemical data is acquired from the test sample.

13. The method of claim 7 wherein the update of the global calibration data set by adding new data comprises:
using the programmable processing device to cluster a new data set into one or more new clusters, wherein the clustering takes place separately from one or more preexisting clusters of the global calibration data set;
combining the one or more new clusters with the one or more preexisting clusters into a new global calibration data set;
pruning one or more clusters from the new global calibration data set; and
updating one or more in-cluster domains and one or more in-cluster error distributions.

14. The method of claim 7 wherein the update of the global calibration data set by adding new data comprises:
using the programmable processing device to cluster a new data set into one or more new clusters, wherein the clustering takes place separately from one or more preexisting clusters of the global calibration data set;
using the programmable processing device to combine the one or more new clusters with the one or more preexisting clusters into a new global calibration data set;
using the programmable processing device to merge two or more clusters in the new global calibration data set; and
updating one or more in-cluster domains and one or more in-cluster error distributions.

15. The method of claim 7 wherein the update of the global calibration data set by adding new data comprises using the programmable processing device to insert new data points one point at a time into one of a current cluster set, wherein each new data point is inserted into a current cluster set most fitting to the each new data point followed by the update of the in-cluster domains and the in-cluster error distributions.

16. The method of claim 7 wherein the update of the global data calibration data set by adding new data comprises at least two of the following:
wherein the update occurs without manual user intervention.
wherein using the programmable processing device to update the global calibration data set is performed in an offline mode.
wherein using the programmable device to perform an evaluation of the one or more measured parameters of the test sample is performed in an online mode when new geochemical data is acquired from the test sample.

17. The method of claim 1 wherein the one or more reservoir quality parameters are selected from the group consisting of: porosity, permeability, total organic carbon, bulk density, SGR, mineralogy, brittleness, and Young's modulus.

18. A system comprising at least a programmable processing device and a memory, the memory storing instructions that when executed by the programmable processing device cause the system to perform a method according claim 1.

19. The system of claim 18 wherein the system comprises a plurality of networked computers.

20. A computer readable storage medium having instructions stored thereon, said instructions when executed causing the computer to perform a method according to claim 1.
